(19) United States
(12) Patent Application Publication
(10) Pub. No.: US 2019/0177143 A1
(43) Pub. Date: Jun. 13, 2019

(54) Aerial Platform Basket Enclosure

(71) Applicant: Forrest Caleb Hester, Seabrook, TX (US)

(72) Inventor: Forrest Caleb Hester, Seabrook, TX (US)

(21) Appl. No.: 16/314,430

(22) PCT Filed: May 3, 2016
(86) PCT No.: PCT/US2016/030607

§ 371 Date: Dec. 30, 2018

(51) Int. Cl. B66F 17/00; B66F 13/00

(52) U.S. Cl. CPC B66F 17/006; B66F 13/00

(57) ABSTRACT

The present innovation is directed to an enclosure for a mechanical lift basket capable of capturing objects that would otherwise fall from the basket. The enclosure may possess an attachment point for netting or material to catch objects dropped outside of the lift basket. The enclosure may be extendable to accommodate lift baskets which are extendable. The enclosure may make use of a lead line to convey air to safety equipment requiring it which would otherwise be unusable in a lift basket. The enclosure may be pressurized to provide protection from toxic fumes or a climate controlled environment.

### BACKGROUND OF THE INVENTION

### Field of the Invention

This disclosure relates to the field of high reach equipment commonly referred to as lifts, scissor lifts, boom lifts, or cherry pickers and more specifically to protection enclosures for the elevated baskets of such lifting equipment.

### Background of the Invention

Scissor lifts, cherry picker lifts, and other lifting platforms are used to gain access to ceilings or elevated areas. During work, users may lose small parts such as bolts or screws, which become lost after falling from the lift. In addition, the user may drop tools or heavy objects which can harm anyone walking or working below the lift. Even small parts can cause injury due to falling from the height of the lift basket.

Those working in mechanical lifts are often exposed to safety hazards or unpleasant working conditions due to the limited space and exposed nature of the basket. Lifts are likewise used in bad weather conditions, where the operator is especially exposed to extreme temperatures or sunlight due to being on the elevated platform of the lift.

Painters, sandblasters, and welders may employ a mechanical lift while working. Their work sometimes involves the use of toxic chemicals, abrasive sand, or welding equipment requiring shielding for protection. This shielding can be difficult to use because it is bulky or too large to be used effectively when the user is working from the confined space available in a mechanical lift. As such, there is need for safety equipment designed specifically to accommodate users of lift baskets in confined spaces and capable of being adapted for use with a variety of lifts and equipment based activities.

### BRIEF DESCRIPTION OF THE DRAWINGS

FIG. 1 shows an aerial platform basket with an aerial platform basket enclosure in accordance with an exemplary embodiment of the invention.

FIG. 1A shows the interaction of the aerial platform basket with the aerial platform basket enclosure in accordance with an exemplary embodiment of the invention.

FIG. 1B shows an aerial platform basket enclosure in use on an aerial platform basket in accordance with an exemplary embodiment of the invention.

FIG. 2 shows a bottom view of an aerial platform basket enclosure in accordance with an exemplary embodiment of the invention.

FIG. 2A shows a bottom view of an aerial platform basket enclosure in which the bottom access point is open for retrieval of parts or tools in accordance with an exemplary embodiment of the invention.

FIG. 3 shows an aerial platform basket enclosure with a roof attachment, glove ports, and tool ports in accordance with an exemplary embodiment of the invention.

FIG. 4 shows an aerial platform basket enclosure for a scissor lift basket with a workspace netting retaining band in accordance with an exemplary embodiment of the invention.

FIG. 4B shows an aerial platform basket enclosure with workspace netting in place to catch parts and tools falling outside the basket enclosure accordance with an exemplary embodiment of the invention.

FIG. 5 shows an aerial platform basket enclosure employing an alternate means of installation in accordance with an exemplary embodiment of the invention.

FIG. 5A shows an aerial platform basket enclosure with an alternate means of installation in the process of being installed on an aerial platform basket in accordance with an exemplary embodiment of the invention.

FIG. 6 shows an aerial platform basket enclosure in which the length of the enclosure is extendable to accommodate the movements of an extendable aerial platform basket in accordance with an exemplary embodiment of the invention.

FIG. 6B shows an aerial platform basket enclosure in which the length of the enclosure is extendable to accommodate the movements of an extendable aerial platform basket, where the basket is in extended position in accordance with an exemplary embodiment of the invention.

FIG. 7A shows an aerial platform basket enclosure in use on an articulating boom lift.

FIG. 7B shows an aerial platform basket enclosure in use on a crane lift in accordance with an exemplary embodiment of the invention.

FIG. 7C shows an aerial platform basket enclosure in use on a scissor lift in accordance with an exemplary embodiment of the invention.

FIG. 7D shows an aerial platform basket enclosure in use on an elevator lift in accordance with an exemplary embodiment of the invention.

### DETAILED DESCRIPTION OF THE PREFERRED EMBODIMENTS

Disclosed here is a means to capture falling objects for retrieval and an enclosure to provide lift workers with a protected and climate controlled work environment. The sides and bottom of the basket are enclosed with a reusable and easily installable material which is strapped, clipped, or otherwise fixed to the handrail of the basket. As the enclosure extends below the basket, falling objects which are not caught by the toeboard of the basket are caught within the enclosing material which extends downward from the top railing and under the basket. The parts can then be accessed through an access point at the bottom of the enclosure for safe retrieval when the lift is lowered without the need to remove the enclosure. In one embodiment, this access point is a zipper which is sewn into the material in a crescent shape to strengthen the material and provide access to the greatest area of the underside of the basket.

The material which forms the enclosure may be fabric, plastic, synthetic fibers, or other materials. One skilled in the art would appreciate different application as suitable to retain dropped materials and provide protection to the user in different environments. Materials used to form the enclosure may include waterproof, fireproof, UV shielded, transparent, abrasion resistant, electrically insulated, puncture resistant, mold resistant materials, or transparent material providing eye protection for use in welding.

A door may be positioned in one side of the enclosure to allow entry and exit from the lift basket. In one embodiment, this would take the form of two double sided zippers allowing access from inside and outside of the basket.

A portion of the enclosing material may be cut out or left open to allow access to controls, or accessories of the lift basket. A drawstring may be used to tighten the fabric around the control panel. One skilled in the art would appreciate other means by which the fabric may be drawn tight around the control panel such as clips, Velcro®, elastic, or straps.

Openings are made in the basket enclosure enabling the lift support attachment point to the basket to move freely. Around the opening or plurality of openings the material is extended into a skirting which may be fastened around the support in such a fashion that no small parts escape through the opening. In one embodiment, this is accomplished by sealing the skirting around the support with a strip of Velcro®. Alternatively, the material may enclose the supports using clips, a drawstring, or other fastening means which would be appreciated by one skilled in the art. Small drains may be present in the bottom of the enclosure to prevent water accumulation. In one embodiment this is accomplished by the use of grommets inserted into the material. The skirting shall be positioned on the lift in such a manner that it does not interfere with the natural movement of the lift. As an additional safety precaution the use of Velcro® allows the skirting to come unfastened if it interferes with the natural movement of the lift basket.

In order to provide environmental protection, the enclosure may be fitted with a roof. The roof may contain a frame for support, and may be fitted with windows and/or ports. The roof may be made from a material which provides solar shielding. In one embodiment the windows may be detachable from the enclosure, as windows may become scratched or damaged, particularly if the user is engaged in activities such as sandblasting. In another embodiment, this is done by inserting a flexible window attached to the enclosure by a zipper. In another embodiment, the window may be tinted in order to provide protection from sunlight or during activities such as welding. In another embodiment, a window or plurality of windows may be located within the fabric of the basket enclosure or roof in order to provide multiple viewing and access locations as required. The roof may be made such that it is detachable from the enclosure when it is not needed. In one embodiment this is done by use of a zipper.

The enclosure may contain an access point for a lead line, which allows the enclosure to take in air creating positive air pressure. The lead line can take in air from outside the affected area. This prevents air from the worksite from entering the enclosure, which provides protection from toxic fumes and allows use of machinery and tools from the mechanical lift which would require an air supply for the user during operation. In another embodiment, the lead line may connect to a filter, pressurized gas, or some other mechanism of providing pressure to the enclosure.

The enclosure may be equipped with a vent to allow air to exit the basket. In addition, the basket may employ a portable climate control unit. This allows the user to work in controlled temperatures.

The enclosure may contain ports for the user to access the work space while protected. In one embodiment, gloves may be attached to the ports to allow for access to the worksite without breaking the seal of the enclosure. In another embodiment, the ports are designed to allow tools to be used through the barrier of the enclosure without exposing the operator to the work environment.

The enclosure may employ a drawstring to tighten loose areas of the enclosing fabric around the control panel of the basket. One skilled in the art would appreciate other means by which fabric may be drawn tight around a protruding area of an enclosed object such as straps or belts. Alternatively, a cutout may be present in the enclosure around the location of the controls to allow free operation of the controls.

In one embodiment, the enclosure may employ a belt or fastener allowing a section of material to be extended between the basket enclosure and an external attachment point. The sheet of material ideally extends under the workspace such that it is able to catch tools and parts that fall outside of the basket. In another embodiment, the material is attached to the material of the basket enclosure by a permanent means and may be folded or stored when not in use.

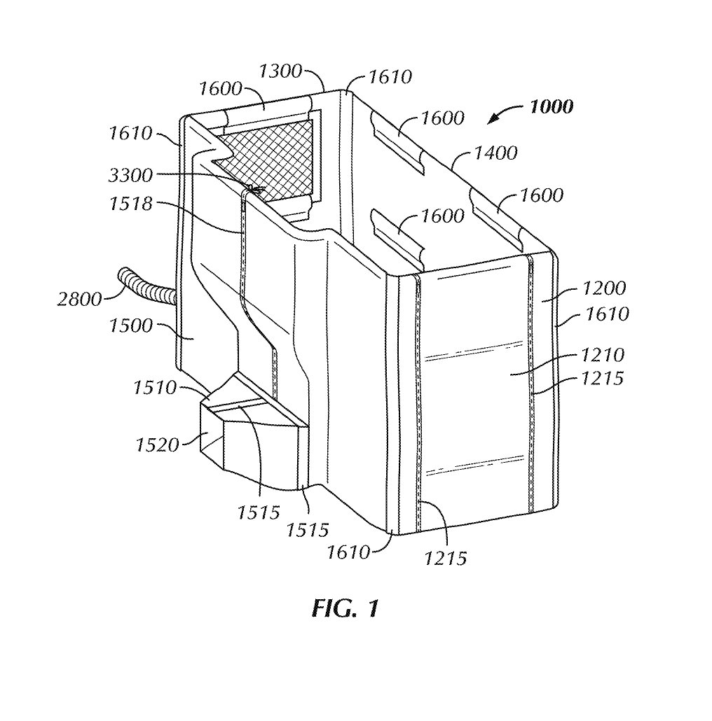

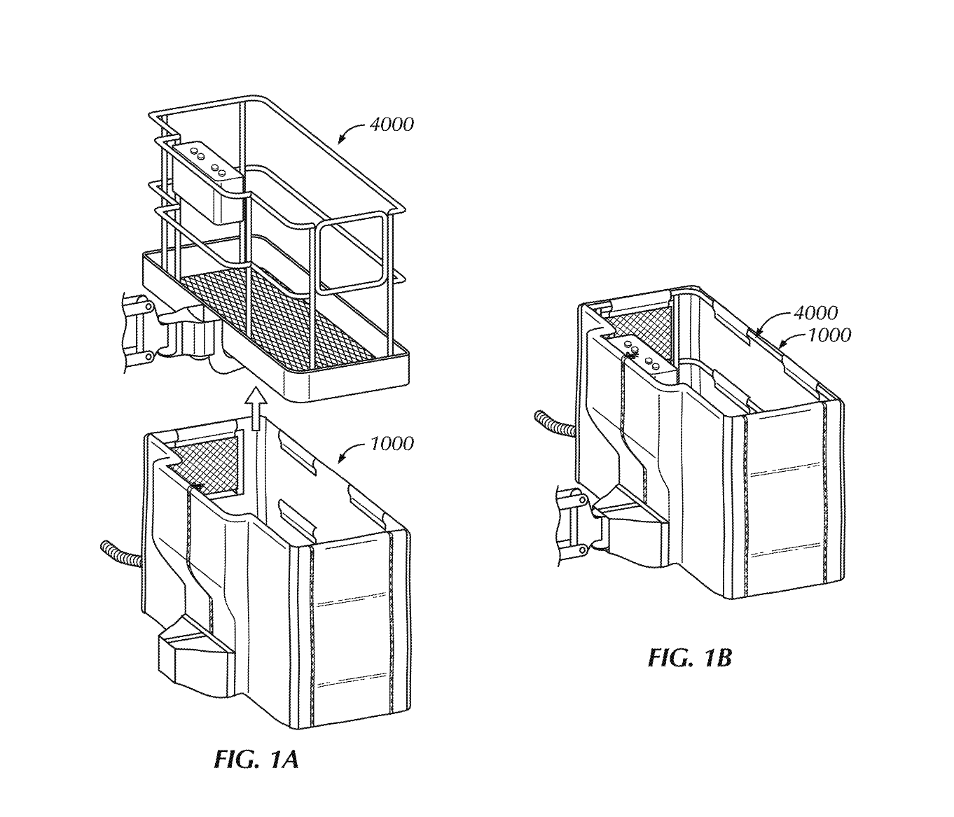

For the present example as shown in FIG. 1, the basket enclosure (1000) encloses a mechanical lift in such a way that the enclosure possesses a bottom (1100) corresponding to and located below the bottom of the lift basket, a door side (1200), a rear side (1300) located across from the door side, and a front side (1400) and back side (1500).

The door side (1200) contains a door (1210) which may be opened from either side using a door access zipper (1215). The door access zipper (1215) may be double sided to allow opening of the door (1210) from inside and outside of the basket enclosure (1000). The back side (1500) contains an attached skirting (1510) which encloses the end of the lifting arm of the basket. The lifting arm protrudes from the skirting opening (1520), which may be tightened around the lifting arm such that no parts or tools may exit through the skirting opening. This may be accomplished by straps, a drawstring, or another enclosing mechanism that ensures that the skirting enclosure is tightly sealed to the lifting arm.

The skirting (1510) may be attached to the back side (1500) by one or more Velcro® straps (1515). The skirting (1510) may alternatively be attached by other fastening means or may be sewn or otherwise permanently joined to the back side (1500). In one embodiment, a back zipper (1518) used to place the basket enclosure (1000) on the basket is located on the back side (1500).

In the present example, the basket enclosure (1000) is positioned on the basket such that it encloses the lift basket. Once the basket enclosure (1000) is positioned properly on the lift basket it is anchored to the handholds of the basket at a set of fastening points (1600). The means to fasten the enclosure to the basket at these points may take the form of clips, clamps, Velcro® straps, ties, and other fastening methods which would be apparent to one skilled in the art.

The skirting (1510) is then closed around the lift arm, and a back zipper (1518) is zipped to hold the basket enclosure (1000) in place. The enclosure is then drawn tight around the top of the lift basket and the edge of any control panel located on the basket by use of a drawstring (3300).

FIG. 1A shows the basket enclosure (1000) and the lift basket (4000). FIG. 1B shows the basket enclosure (1000) enclosing the lift basket (4000).

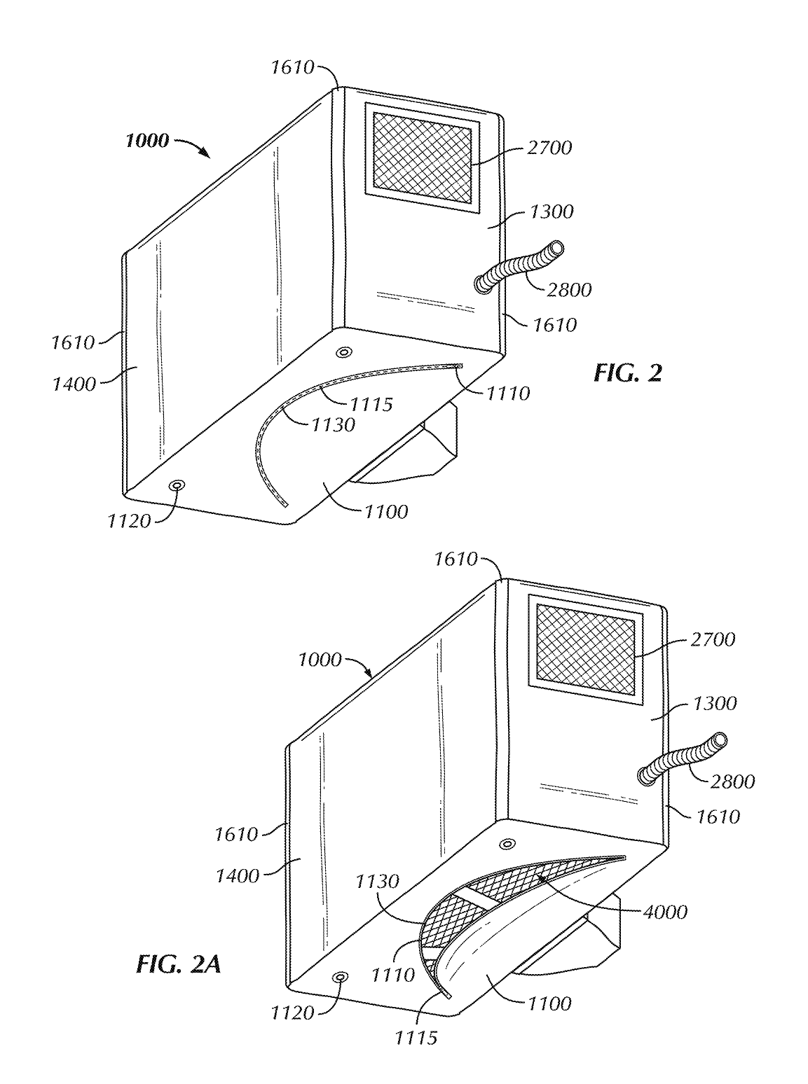

FIG. 2A shows a bottom view of the basket enclosure (1000). The bottom (1100) of the basket enclosure (1000) has a bottom access point (1110) allowing the removal of parts which fall within the lift basket without requiring the removal of the basket enclosure (1000) from the lift basket. The bottom access point (1110) may consist of a half moon shaped floor access opening (1130) which may be sealed by a bottom access zipper (1115). The bottom (1100) may further contain a drain (1120). Ideally, the drain is small or meshed over so that no small parts can be lost through the drain (1120). In one embodiment, the drain (1120) is a grommet inserted into the material of the bottom (1100).

FIG. 2B shows the bottom view as shown in FIG. 2A, where the bottom access zipper (1115) has been opened providing access to the bottom of the lift basket.

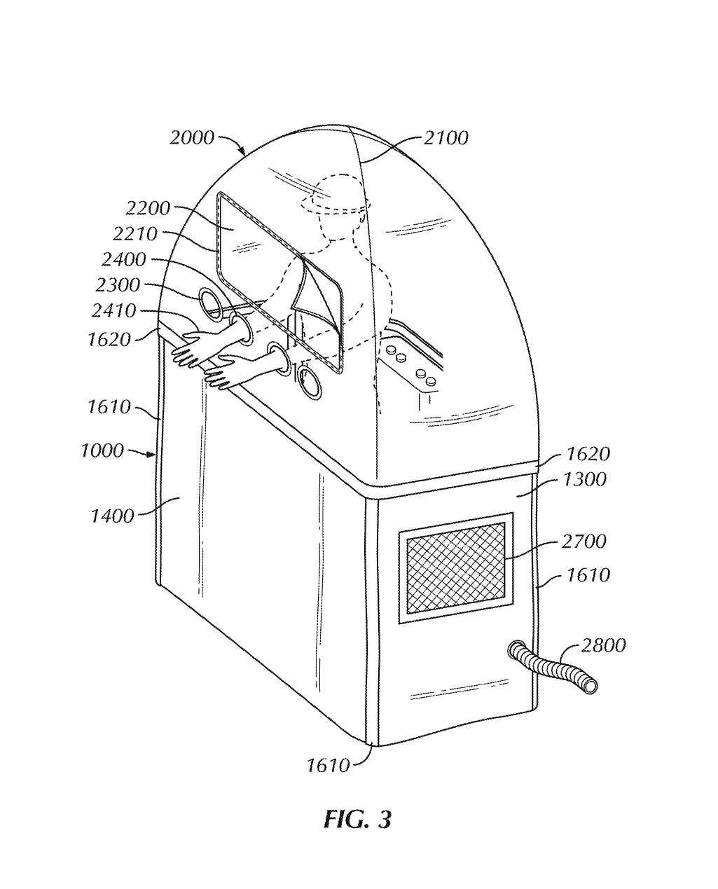

FIG. 3 shows an alternate embodiment of the described innovation in which the basket enclosure 1000 as shown in FIGS. 1 and 2 further contains a roof (2000). The roof (2000) may be made of one of various protective materials such as fireproof material, UV proof material, chemical resistant material, abrasion resistant material, transparent or sun shaded material, or transparent material suitable to serve as a welding screen for a user within the basket.

In one embodiment the roof (2000) may be removable and fixed to the basket enclosure (1000) at one or more roof fastening points (1620) The roof may be supported by a roof frame (2100). In one embodiment the roof frame (2100) is shaped similar to a tent frame, and may be collapsible when not in use.

A window (2200) may be placed within the roof (2000) section of the basket enclosure (1000). In the embodiment shown the window (2200) is removable via a window zipper (2210). This allows the window (2200) to be removed to allow the user to access the work area. This is useful for the purposes of sand blasting and abrading from the lift basket, as abrasive sand may scratch the window (2200) and obscure visibility. In place of a window (2200), in one embodiment the roof (2000) may be made of a transparent material. In another embodiment, the window or transparent material provides eye protection to a welder working within the lift basket.

The basket enclosure (1000) as shown contains one or more tool ports (2300) and glove ports (2400). Gloves (2410) are attachable to the glove ports (2400). The gloves (2410) may be removable for the purposes of replacement, as they may become damaged during chemical work, sandblasting, or welding.

The basket enclosure (1000) as shown further includes a lead line (2800) and vent (2700). The lead line (2800) may be connected to an air pump in order to provide air from outside the workspace or for pairing with the breathing apparatus of specialized welding and chemical application equipment. The pumped air may be used to create positive air pressure within the basket, allowing the user to work within an environment isolated from any hazardous or unpleasant conditions present in the work environment. In one embodiment, the basket may further contain a climate control unit or the lead line (2800) may pump climate controlled air.

FIG. 4 shows an embodiment of the innovation in which the lift basket enclosure (1000) has a workspace netting retaining band (4100). The workspace netting retaining band (4100) is used to anchor netting or a solid sheet of material between the lift basket enclosure and a secondary point of fixation located at or near the workspace. The material or netting serves as a workspace netting (4200), which retains and captures dropped tools or parts which fall outside of the basket enclosure so that they do not injure workers below or become lost.

FIG. 4B shows the workspace netting (4200) in place and capturing parts, secured by the workspace netting retaining band (4200).

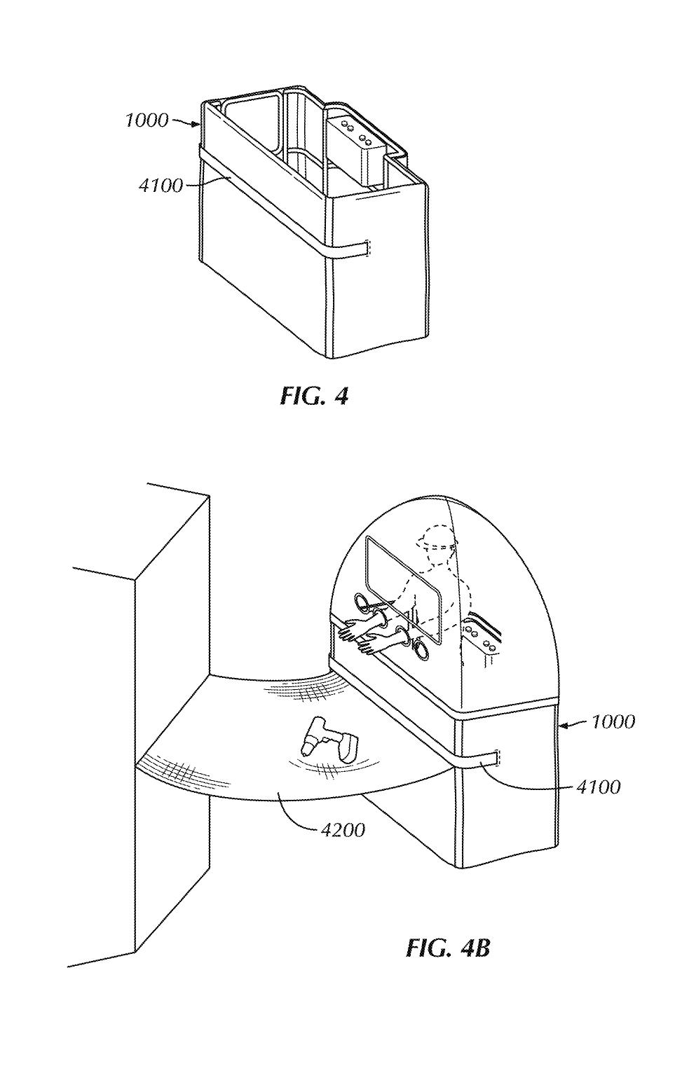

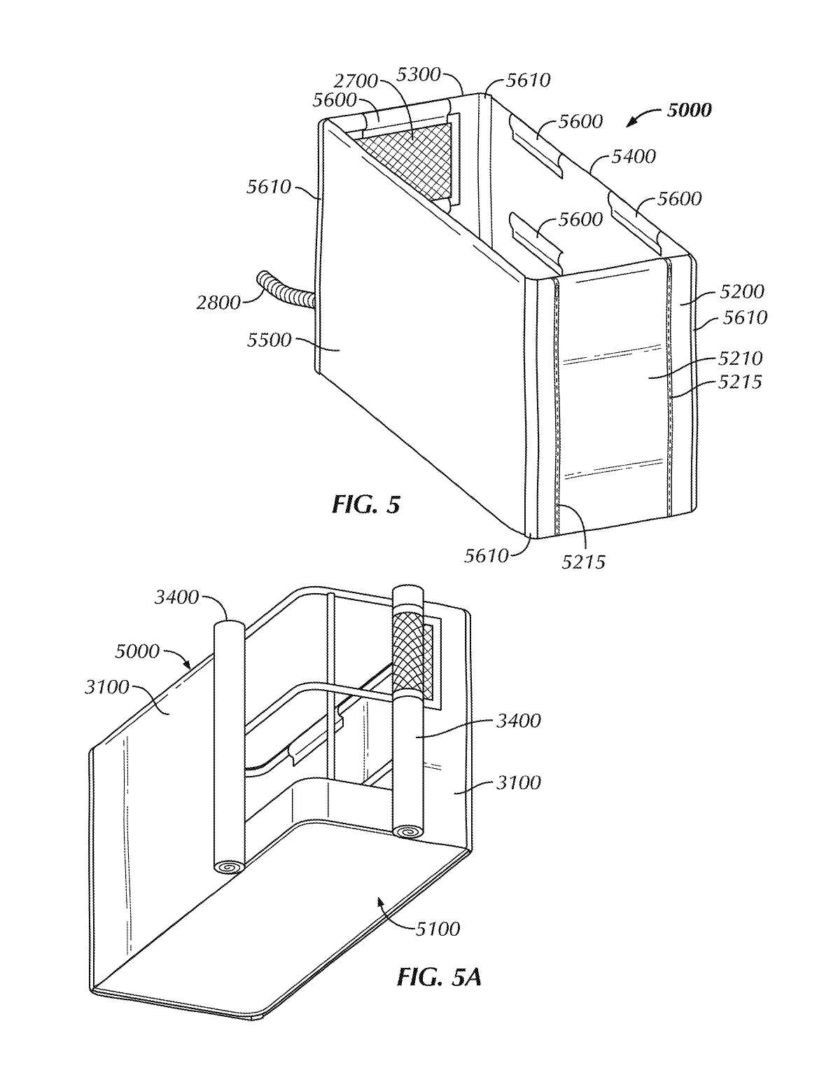

FIG. 5 shows an alternate means of applying a basket enclosure (1000) to the lift basket of a scissor lift. In this embodiment, Velcro® straps (5610) are used to join the sides of the basket enclosure (1000).

FIG. 5A shows the process by which the alternate basket enclosure (5000) The material forming the basket enclosure (5000) may be rolled onto the basket without the need for zippers or a bottom section. The basket enclosure (5000) as shown in FIG. 4 is bottomless to accommodate the alternate lifting mechanism of a scissor lift (5100).

The rear side (5300), vent (2700), fastening points (5600), lead line (2800), back side (5500), front side (5400), door side (5200), door (5210), and door zipper (5215) function as described in previous embodiments.

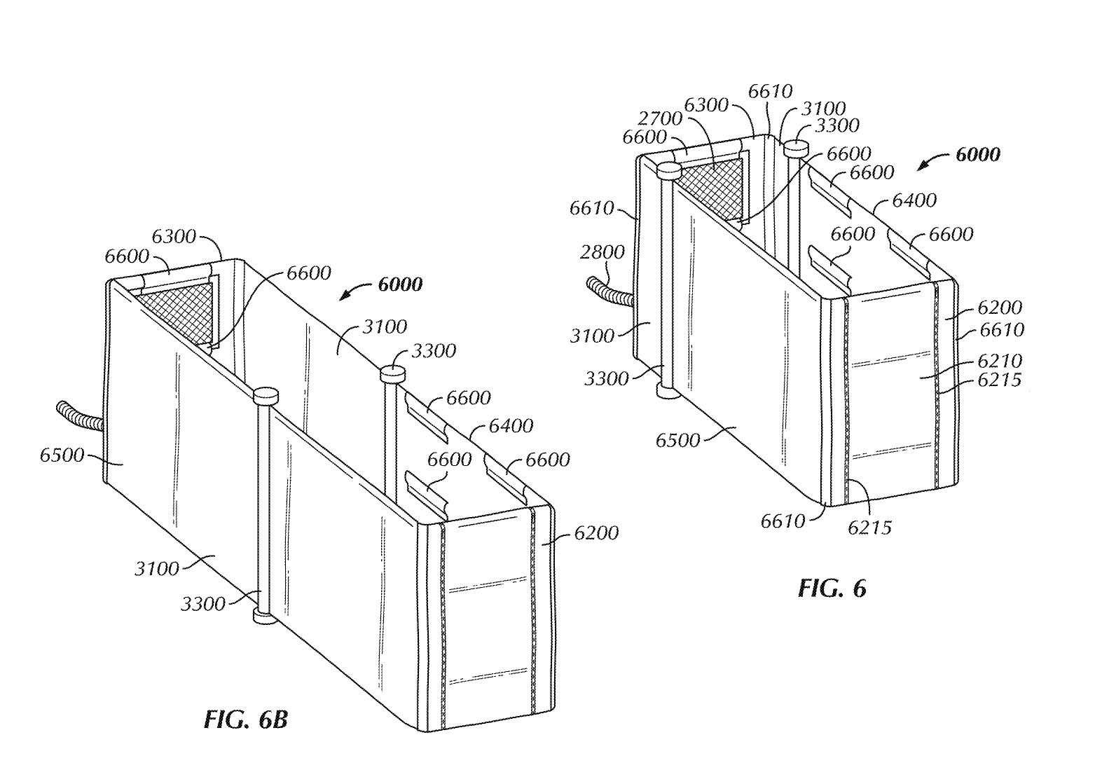

FIG. 6 shows an alternate embodiment in which the basket enclosure (6000) is designed for use with a lift basket having an extendable base. As the base of the lift is extended, a roll (3300) of extendable material (3100) unrolls more material to accommodate the increased length of the base. The basket enclosure (6000) shown is bottomless to accommodate the lifting mechanism of the lift and the variable size of the base of the lift basket.

The rear side (6300), vent (2700), fastening points (6600), lead line (2800), back side (6500), front side (6400), door side (6200), door (6210), and door zipper (6215) function as described in previous embodiments.

FIG. 6B shows the alternate lift basket enclosure (6000) where the lift basket base is in extended position.

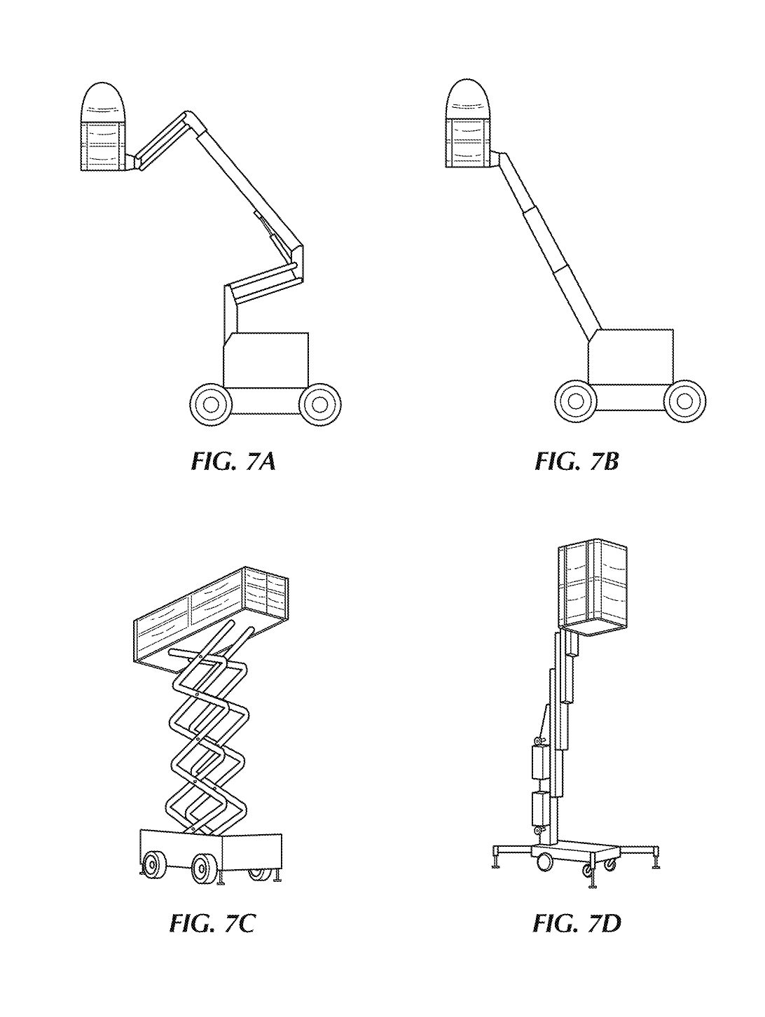

FIGS. 7A, 7B, 7C, and 7D show the lift basket enclosure customized to fit an assortment of mechanical lifts. One skilled in the art would appreciate the capability of the lift basket enclosure to be modified to accommodate the dimensions and properties of cherry-picker lifts, scissor lifts, crane lifts, and other mechanical lift mechanisms.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An enclosure for a lift basket comprising;
a door side;
a rear side; a front side;
a back side; and
a bottom,
wherein the sides correspond to sides of the lift basket such that the basket is enclosed by the material of the sides, and the sides of the enclosure are removably attached to the sides of the lift basket.

2. An enclosure as described in claim 1, wherein the sides further comprise a semi-rigid structure to support and extend the sides upward from the top of the lift basket to a sufficient height to enclose an operator/worker.

3. An enclosure as described in claim 2, wherein the semi-rigid structures are air channels formed at the corners of one or more sides, and sealed to be inflated with a sufficient air pressure to provide a semi-rigid tube of the air channel

4. An enclosure as describe in claim 2 wherein the semi-rigid structures are framing structures secured to the lift basket's existing rails and extending to the desired height.

5. An enclosure as described in claim 1, wherein the bottom of the enclosure further comprises a bottom access for removing items retained in the bottom of the enclosure which may be under the bottom of the lift basket.

6. An enclosure as described in claim 1, further comprising a skirting of a subsection substantially adjacent to the lift basket which does not inhibit operation of the lifting mechanism.

7. An enclosure as described in claim 1, wherein the enclosure further comprising
a lead line;
wherein the lead line provides air and/or equipment service lines.

8. An enclosure as described in claim 1, further comprising an attachment point for material, where the material extends from the basket to or near the work surface to catch objects falling outside of the lift basket.

9. An enclosure as described in claim 1, further comprising
a roof;
wherein the roof is affixed to the sides of the enclosure such that the roof is supported by the sides of the enclosure and forms a cover over the enclosure.

10. An enclosure as described in claim 9, further comprising
a window removably affixed to a side or the roof of the enclosure.

11. An enclosure as described in claim 9, wherein the material of the enclosure is transparent.

12. An enclosure as described in claim 9, wherein the material of the enclosure is tinted to provide eye protection.

13. An enclosure as described in claim 9, further comprising
a lead line;
wherein the enclosed area may be pressurized such that air within the enclosed area of the basket may be isolated from the surrounding environment.

14. An enclosure as described in claim 13, further comprising
tool ports;
wherein the tool ports are affixed within the material of the enclosure such that tools may pass outside the material of the enclosure.

15. An enclosure as described in claim 13, further comprising
gloves affixed to the pressurized enclosure and extending outward to allow an operator to manipulate objects in the work space while maintaining a pressurized environment within the enclosure.

16. An enclosure for a lift basket comprising;
a door side;
a rear side; a front side; and
a back side; wherein the sides correspond to sides of the lift basket such that the basket is enclosed by the material of the sides, the sides of the enclosure are anchored to the sides of the lift basket, wherein the sides of the enclosure may be extended to accommodate an extendable lift basket.
